(19) United States
(12) Patent Application Publication
(10) Pub. No.: US 2023/0406039 A1
(43) Pub. Date: Dec. 21, 2023

(54) Chassis and Use Thereof

(71) Applicants: Tobias RITZENHÖFER, Schöppingen (DE); Teupen Maschinenbau GmbH, Gronau (DE)

(72) Inventor: Tobias Ritzenhöfer, Schöppingen (DE)

(21) Appl. No.: 18/033,355

(22) PCT Filed: Nov. 10, 2021
(86) PCT No.: PCT/EP2021/081248

§ 371 Date: Apr. 24, 2023

(30) Foreign Application Priority Data
Nov. 20, 2020 (DE) 102020130811.6

(51) Int. Cl. B60B 35/10; B62D 24/00; B62D 21/14

(52) U.S. Cl. CPC B60B 35/1072; B60B 35/1045; B60B 35/1054; B60B 35/1063; B62D 24/00; B62D 21/14

(57) ABSTRACT

The invention relates to a chassis comprising a base (12) and four wheels (14) each being mounted on the base by way of a respective supporting device (16) and each being capable of being brought out of a transport position into an operating position of the chassis (10), and vice versa, wherein each supporting device comprises a support or carrier arm (18), which is arranged on the base via a proximal end (20) to be pivotable out of the transport position into the operating position of the chassis, and vice versa, and at a distal end (22) receives an axle journal (24) for rotation, a first control (30) for pivoting the support or carrier arm out of the transport position into the operating position of the chassis, and vice versa, the axle journal rotatably arranged at the distal end of the support or carrier arm, a stub axle (40), which is pivotably arranged on the axle journal and receives the wheel for rotation at a distal end (42) of the axle journal; and a second control (44) for pivoting the stub axle against the axle journal.

### CROSS REFERENCE TO RELATED APPLICATIONS

This application is the U.S. national stage of International Application No. PCT/EP2021/081248, filed on 2021 Nov. 10. The international application claims the priority of DE 102020130811.6 filed on 2020 Nov. 20; all applications are incorporated by reference herein in their entirety.

### BACKGROUND

The invention relates to a chassis, a method of operating a mobile or self-propelled working machine, working platform or the like with such a chassis, and the use thereof.

Chassis of this type are generally known. These chassis are used, for example, as underframes of mobile or self-propelled machines, working platforms or the like, also known as boom lifts. These chassis usually comprise a base and four wheels arranged on the base via a supporting device in each case. The wheels can be brought from a transport position into an operating position of the chassis, and vice versa. In the transport position, the chassis have a smaller width than in the operating position. The supporting devices therefore serve to adjust the width of the chassis. Such a chassis is known, for example, from EP 2 641 860 B1. In practice, the mimic of the supporting devices has proved to be disadvantageous. For example, width adjustment is performed exclusively by extending or retracting, respectively, telescopic support or carrier arms perpendicular to the longitudinal axis of the chassis and the four wheels. As a result, the individual components such as the wheels or the chassis itself are subjected to extremely large lateral or transverse, respectively, forces when the chassis is brought from its transport position into its operating position, and vice versa. On the one hand, this necessitates overdimensioning of all components, including any actuating devices provided, for example, for extending and retracting the support or carrier arms. This in turn leads to an increase in the tare weight of the chassis and, at the same time, a reduction in the maximum permissible working weight in/during its operation. On the other hand, the constant load situation has a detrimental effect on the service life of the undercarriage as a whole.

### SUMMARY

The object of the present invention is therefore to provide a chassis with which the above disadvantages can be avoided, which is therefore constructively particularly simple, at the same time compact and stable, is not or at least only very slightly exposed to the impact of lateral or transverse, respectively, forces, is of considerably reduced weight and has an exceptionally long service life and, not least because of this, is exceptionally cost-effective to operate, a method for operating a mobile or self-propelled working machine, working platform or the like with such a chassis, and its use.

With regard to the technical device, this object is achieved in a surprisingly simple manner by the features of claim 1.

### DETAILED DESCRIPTION

By means of the chassis according to the invention comprising a base and four wheels each being mounted on the base by way of a respective supporting device and each being capable of being brought out of a transport position into an operating position of the chassis, and vice versa, wherein each supporting device comprises a support or carrier arm, which is arranged on or at, respectively, the base via a proximal end to be pivotable out of the transport position into the operating position of the chassis, and vice versa, and at a distal end receives an axle journal for rotation, a first control or a first operating device, respectively, for pivoting the support or carrier arm out of the transport position into the operating position of the chassis, and vice versa, the axle journal rotatably arranged at the distal end of the support or carrier arm, a stub axle, which is pivotably arranged on the axle journal and receives the wheel for rotation at a distal end of the axle journal, and a second control or a second operating device, respectively, for pivoting the stub axle against the axle journal, a particularly simple, furthermore compact and stable construction of the chassis as a whole is achieved. Due to the constructive possibility of adjusting the wheels during a width adjustment of the chassis from a transport position to an operating position of the chassis, and vice versa, the wheels and other components of the chassis and ultimately the chassis itself are subjected to considerably smaller transverse forces. This results in a reduction in the dimensions of the individual components and of the chassis as well as, consequently, in a considerable reduction in the weight of the latter. Accordingly, it is possible to achieve a design that is less susceptible to repair and, not least as a result, an exceptionally long service life for the chassis according to the invention. The operation of the chassis according to the invention can also be designed to be extremely cost-effective overall.

Further advantageous structural details of the chassis in accordance with the invention are described in claims 2 to 13.

The features of claim 2 are of particular interest. Accordingly, the support or carrier arm is rotatably arranged on the base with the proximal end via a first axis of rotation from the transport position to the operating position of the chassis, and vice versa, and is rotatably connected to the axle journal at the distal end via a second axis of rotation.

In this connection it is of particular advantage, that the first control for pivoting the support or carrier arm from the transport position into the operating position of the chassis, and vice versa, according to claim 3 is rotatably arranged on the base with a proximal end via a first axis of rotation and is rotatably connected to the axle journal at a distal end via a second axis of rotation.

According to the measures of claim 4, the second axis of rotation of support or carrier arm and axle journal and the second axis of rotation of first control and axle journal preferably coincide.

Moreover, the constructive measures of claim 5 are of particular interest. Accordingly, the first control and/or the second control is/are designed to be adjustable in length.

Furthermore, it is within the framework of the invention that the first control and/or the second control according to claim 6 is/are designed to be hydraulically, pneumatically, mechanically or electrically length-adjustable.

Furthermore, the first control and/or the second control according to claim 7 is/are preferably designed as a, in particular telescopic or telescopically acted, respectively, pressure cylinder, hydraulic unit, linear unit, spindle unit or linear motor.

The features of claim 8 are of particular great relevance wherein each supporting device further comprises a parallel guide assigned to the support or carrier arm, rotatably arranged at a proximal end on the base and rotatably connected at a distal end to the axle journal. By means of the parallel guides of the vehicle chassis according to the invention a series of further advantages may be reached in a simple way. On the one hand, thus the overall stability of the vehicle chassis according to the invention can be further increased and accordingly its service life can be additionally extended. On the other hand, the tracking accuracy and fidelity of the vehicle chassis and accordingly a simplified, equally very precise handling of the vehicle chassis in operation may be achieved. Finally, the parallel guides provide an exceptionally effective protection of the first controls against damage or even complete destruction in the event of a collision with possible obstacles on the travel path of the vehicle chassis due to carelessness by the operating personnel.

Moreover, it is provided by the invention that the parallel guide according to claim 9 is arranged between the support and carrier arm and the longitudinal axis of the chassis, in particular substantially parallel to the support and carrier arm.

According to the features of claim 10, the parallel guide and the support and carrier arm together with the base and the axle journal form approximately the shape of a parallelogram.

According to the measures of claim 11, the first axis of rotation of parallel guide and base and the first axis of rotation of first control and base coincide.

Preferably, the wheels and/or the first control and/or second control according to claim 12 is/are designed to be controllable individually, in pairs or all together.

Furthermore, it is within the framework of the invention that the base of the vehicle chassis according to claim 13 has a turntable, slewing ring or similar bearing device, via which a superstructure, revolving tower, work cage, work platform or other lifting device for the transport of persons and tools can be arranged in a rotatable manner.

This object is achieved furthermore, with regard to a method, in a surprisingly simple manner by the features of claim 14.

Accordingly, a method of operating a mobile or self-propelled working machine, working platform or the like having a chassis is proposed wherein the wheels on the supporting devices are each aligned for moving or adjusting the width of the chassis from the transport position to the operating position, and vice versa, each at an angle to the longitudinal axis of the vehicle chassis in such a way that the wheels are each guided or aligned on, substantially on or parallel to a pitch circle about which/on which the supporting devices are pivoted or moved.

Finally, it is still within the framework of the invention to use the vehicle chassis according to claim 15 for mobile, movable, lifting and lowering, self-propelled working machines, working platforms, working cages, working platforms, excavators, machines for dredging, walking excavators, construction equipment and machines, boom lifts, earth-moving machines, earth drills, lifting platforms, lifting equipment for the transport of people and goods, hoists, aerial work platforms, lifting platforms, lifting tables, cranes, slewing cranes, construction cranes, truck cranes, overhead cranes, gantry cranes, tower cranes, crane or tool attachments or mounts for machine tools.

### BRIEF DESCRIPTION OF THE DRAWINGS

Further features, advantages and details of the invention are contained in the following description of preferred embodiments of the invention, and in connection with the drawings. The drawings are as follows:

FIGS. 1A and 1B Perspective views of an embodiment of a vehicle chassis designed according to the invention in a transport position and in an operating position,

FIGS. 2A to 2D plan views of the embodiment of the vehicle chassis of FIGS. 1A and 1B designed according to the invention to illustrate a width adjustment from the transport position via a first and a second intermediate position into the operating position, and vice versa,

FIGS. 3A and 3B schematic top views of the embodiment of the vehicle chassis designed according to the invention in accordance with FIGS. 2A and 2B or 2C and 2D, respectively,

FIGS. 4A to 4C a side view and two sectional views through the embodiment of the vehicle chassis designed according to the invention as shown in FIGS. 1A to 3B in accordance with line IV-IV in FIG. 4A,

FIG. 5 a schematic top view of the embodiment of the vehicle chassis designed according to the invention in accordance with FIGS. 2A to 2D,

FIGS. 6A and 6B perspective views of a further embodiment of a vehicle chassis designed according to the invention in a transport position and in an operating position,

FIGS. 7A to 7D plan views of the further embodiment of the vehicle chassis of FIGS. 6A and 6B designed according to the invention to illustrate the width adjustment from the transport position via a first and a second intermediate position into the operating position, and vice versa,

FIGS. 8A and 8B schematic top views of the further embodiment of the vehicle chassis designed according to the invention in accordance with FIGS. 7A and 7B or 7C and 7D, respectively,

FIGS. 9A to 9C a side view and two sectional views through the embodiment of the vehicle chassis designed according to the invention as shown in FIGS. 6A to 8B in accordance with line IX-IX in FIG. 9A, and

FIG. 10 a schematic top view of the embodiment of the vehicle chassis designed according to the invention in accordance with FIGS. 8A to 8D.

### DETAILED DESCRIPTION OF THE PREFERRED EMBODIMENTS

In the following description of various embodiments of a vehicle chassis 10 designed according to the invention, corresponding identical components are each provided with identical reference numbers.

The vehicle chassis 10 of the invention is preferably used for mobile, movable, lifting and lowering, self-propelled working machines, working platforms, working cages, working platforms, excavators, machines for dredging, walking excavators, construction equipment and machines, boom lifts, earth-moving machines, earth drills, lifting platforms, lifting equipment for the transport of people and goods, hoists, aerial work platforms, lifting platforms, lifting tables, cranes, slewing cranes, construction cranes, truck cranes, overhead cranes, gantry cranes, tower cranes, crane or tool attachments or mounts for machine tools.

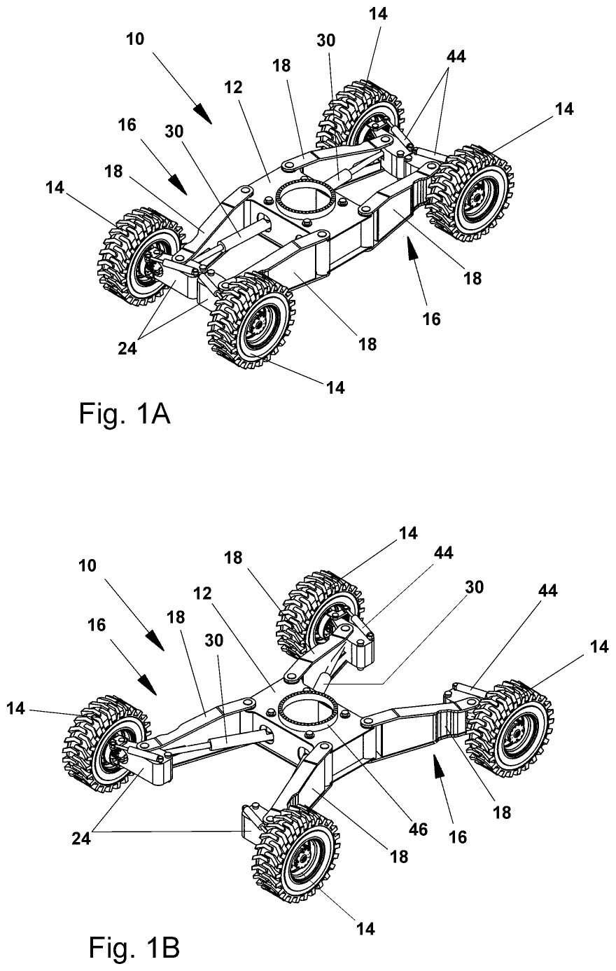

In FIGS. 1A to 5 is shown an embodiment of a chassis 10 according to the invention, the components and operation of which are described in detail below.

According to this, the chassis 10 comprises a base 12 and four wheels 14 each being mounted on the base 12 by way of a respective supporting device 16. By way of the supporting device 16, the four wheels 14 are capable of being brought out of a transport position according to FIG. 1A into an operating

position of the chassis 10 according to FIG. 1B. In the transport position, the chassis 10 has a smaller width than in the operating position.

In the operating position, a working machine (not shown) starts normal operation.

Without being further explained in detail, the four wheels 14 in turn can be/are equally transferred back from the operating position of the chassis 10 according to FIG. 1B to the transport position according to FIG. 1A by means of the respective supporting device 16 after use and termination of the normal operation of the working machine, in order to then be able to transport the chassis 10, for example, on a low-loader of a truck for transfer to the next place of use.

Each supporting device 16 comprises a support or carrier arm 18.

The support or carrier arm 18 is arranged on the base 12 via a proximal end 20 to be pivotable out of the transport position into the operating position of the chassis 10, and vice versa. Furthermore, the support or carrier arm 18 at a distal end 22 rotatably receives an axle journal 24.

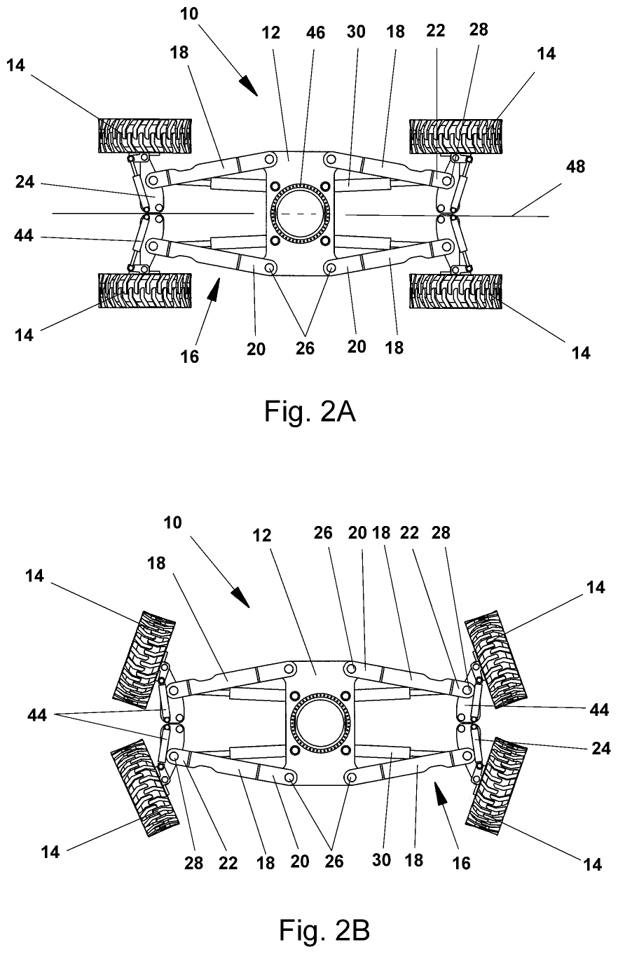

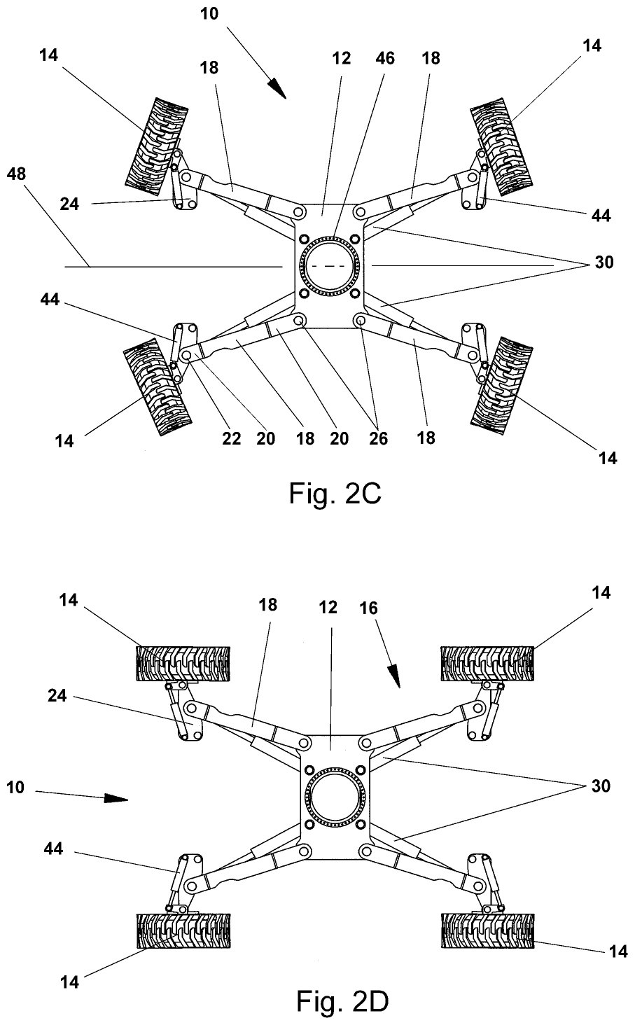

In this regard, as shown in FIGS. 2A to 3B and 4B to 5, the support or carrier arm 18 is rotatably arranged at the base 12 with the proximal end 20 about a first pivot axis 26. In addition, a second pivot axis 28 is provided at the distal end 22 of the support or carrier arm 18 by which the axle journal 24 is pivotally or rotatably connected, respectively, to the support or carrier arm 18.

Furthermore, each supporting device 16 comprises a first control or a first operating device, respectively, 30. The first control 30 is provided for pivoting the support or carrier arm 18 out of the transport position into the operating position of the chassis 10, and vice versa.

The first control 30 is rotatably arranged to the base 12 via a proximal end 32 and rotatably connected to the axle journal 24 at a distal end 34. To this end, a first axis of rotation 36 acting between the base 12 and the proximal end 32 of the first control 30 and a second axis of rotation 38 acting between the distal end 34 and the axle journal 24 are provided.

In the embodiment of the chassis of FIGS. 1A to 5, the second axis of rotation 28 of support or carrier arm 18 and axle journal 24 and the second axis of rotation 38 of first control 30 and axle journal 24 coincide. This simplifies the design and at the same time allows for further weight savings.

As previously stated, each supporting device 16 further comprises the axle journal 24 rotatably arranged on the distal end 22 of the support or carrier arm 18.

In addition, each supporting device 16 has a stub axle 40 for receiving the respectively assigned wheel 14 for rotation at a distal end 42 of the axle journal 24. The stub axle 40 itself is also hinged to the axle journal 24 so that it can be pivoted, when adjusting the width or widening the track, respectively, of the chassis 10 from the transport position into the operating position, and vice versa, as well as for steering the chassis 10 in normal operation.

Each supporting device 16 finally has a second control or a second operating device, respectively, 44 for pivoting the stub axle 40 relative to or against, respectively, the axle journal 24.

With the embodiment of the chassis 10 according to the invention, a particularly simple, moreover compact and stable design of the chassis 10 or chassis as a whole, respectively, can be obtained. Due to the constructive possibility of adjusting the wheels 14 during the width adjustment or track widening, respectively, of the chassis 10 from the transport position into the operating position of the chassis 10, and vice versa, the individual components of the chassis 10 and ultimately the chassis 10 itself are subjected to negligibly small lateral or transverse, respectively, forces. Consequently, the dimensions of support or carrier arm 18, of the first and second controls 30, 44 or other components and of the chassis 10 as a whole can be reduced, thus saving weight. Accordingly, it is possible to achieve a design that is less susceptible to repair and, not least as a result, an exceptionally long service life for the chassis 10. The operation of the chassis 10 is also particularly cost-effective as a result.

The first control 30 and/or the second control 44 is/are preferably designed to be adjustable in length. Preferably, in this respect, the first control 30 and/or the second control 44 is/are designed to be hydraulically, pneumatically, mechanically or electrically length-adjustable.

In this context, an pressure cylinder, in particular telescopically acting, most preferably an adjustment cylinder or steering cylinder, has proven to be particularly advantageous as the first control 30 or second control 44, respectively, in practice. Alternatively, a design of the first control 30 and/or of the second control 44 as a hydraulic unit, linear unit, spindle unit or linear motor would also be advantageous.

Without being shown in detail, individual, paired or all common control of the wheels 14 and/or of the first control 30 and/or of the second control 44 is preferably provided.

Finally, the base 12 of the chassis 10 according to the invention in accordance with FIGS. 1A to 5 is provided with a
preferably centrally mounted—turntable 46, slewing ring or similar bearing device, whereby a superstructure, revolving tower, work cage, work platform or other lifting device for transporting persons and tools (all not shown) can be rotatably arranged on the chassis 10.

In the following, the method according to the invention for width adjustment or track widening, respectively, of the chassis 10 according to the invention, for example of a self-propelled working machine, from the transport position into the operating position is explained in more detail with reference to FIGS. 2A to 2D:

In the transport position shown in FIG. 2A, the brakes of the wheels 14 are first released so that the wheels 14 are in free circulation and can rotate freely. In this way, stress and wear of the wheels 14 as well as abrasion marks on the floor or ground, respectively, can be avoided.

Then, in a first intermediate position shown in FIG. 2B, the wheels 14 are brought to an angle which is tangential to the (partial) circular path of the respective associated support and carrier arms 18. Precise control is preferably provided by an angle or also length sensor (not shown), which is located in the second control 44, such as a steering cylinder.

In other words, the wheels 14 are each oriented on the supporting devices 16 at an angle to the longitudinal axis 48 of the chassis 10 for moving or for adjusting the width of the chassis 10 from the transport position into the operating position, and vice versa. Thereby, the wheels 14 are each guided or aligned on, substantially on, or parallel to a pitch circle about which/on which the supporting devices 16 are pivoted or moved from the transport position into the operating position, and vice versa.

According to FIG. 2C, the support and carrier arms 18 are then moved by the first control 30, i.e., from the transport position or the first intermediate position, respectively, in which the support or carrier arms 18 are still approximately parallel to the longitudinal axis 48 of the chassis 10, to a second intermediate position.

In the second intermediate position, the support or carrier arms 18 are virtually folded or spread, respectively, outwards away from the longitudinal axis 48 of the chassis 10. Here, precise control is again preferably provided by the angle or also length sensor located in the second control 44. The wheels 14 simply rotate with it.

After the second intermediate position, the wheels 14 are finally moved to the working position, as can be seen in FIG. 2D, via the second controls 44, for example the steering cylinders, parallel to one another or to the longitudinal axis 48, respectively, again. Here, too, precise control is preferably again performed by the angle or also length sensor in the second control 44.

In the working position according to FIG. 2D, the brakes of the wheels 14 are closed again.

The method for adjusting the width or widening the track, respectively, of the chassis 10 according to the invention is therefore completed.

The working machine (not shown) changes to normal operation and is now available to the operating personnel for the intended work operation.

After use and also termination of the normal operation of the working machine, the above procedure is to be carried out in reverse order. The four wheels 14 are thus transferred via the respective supporting device 16 from the operating position of the chassis 10 according to FIG. 1B back via the two intermediate positions into the transport position according to FIG. 1A, in order to then be able to transport the chassis 10, for example on a low-loader of a truck, for transfer to the next place of use.

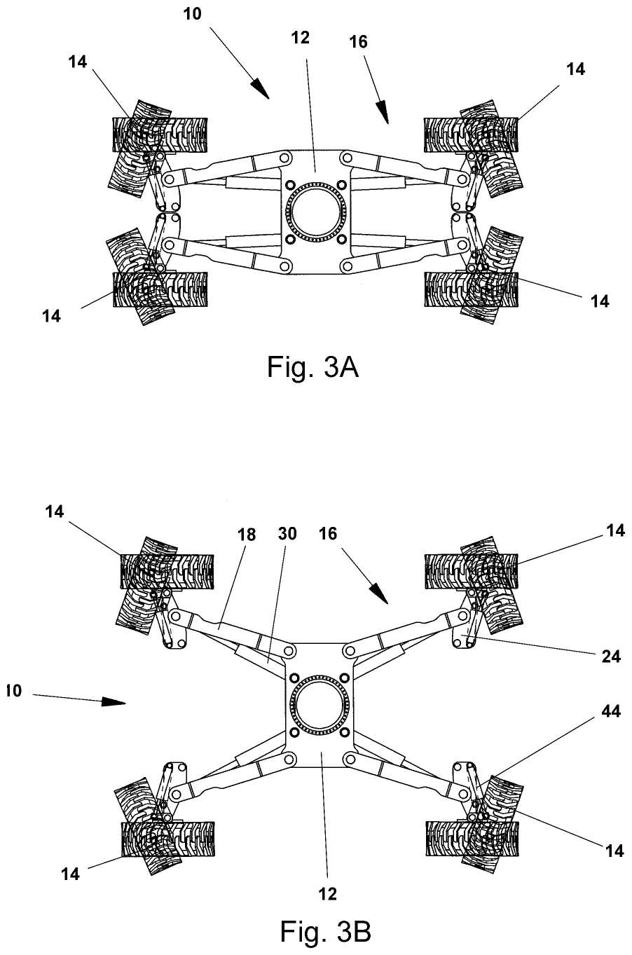

In FIG. 3A or 3B, respectively, the respective steering settings of the four wheels 14 from the transport position to the first intermediate position or ultimately from the second intermediate position to the operating position, respectively, of the chassis 10, and vice versa, are schematically shown or summarized, respectively.

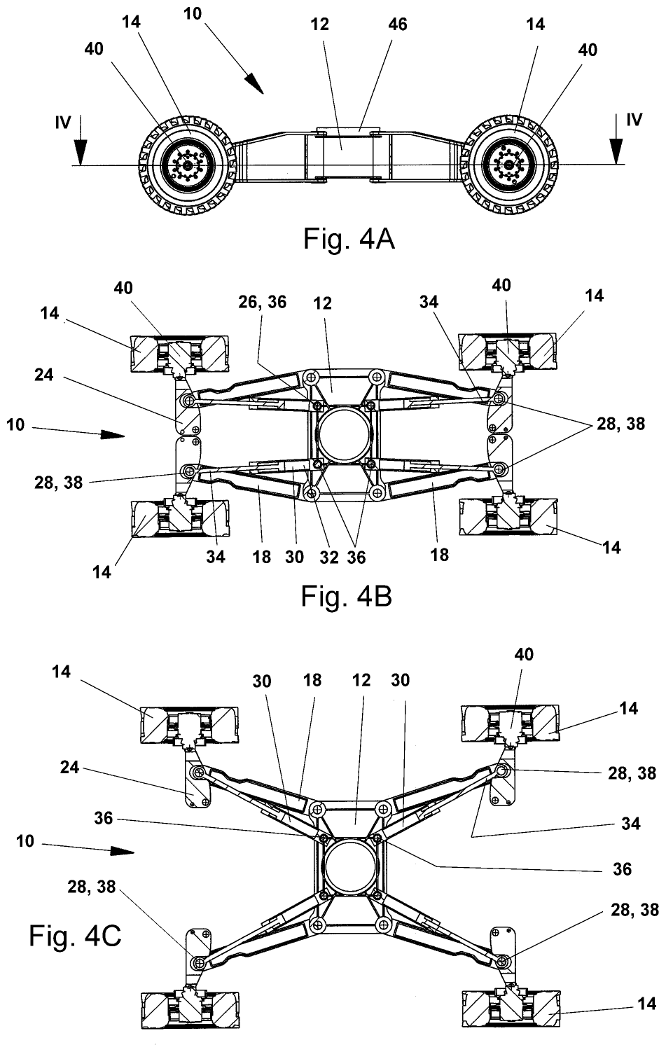

In FIGS. 4A to 4C in particular the linkages of the first control 30 are illustrated.

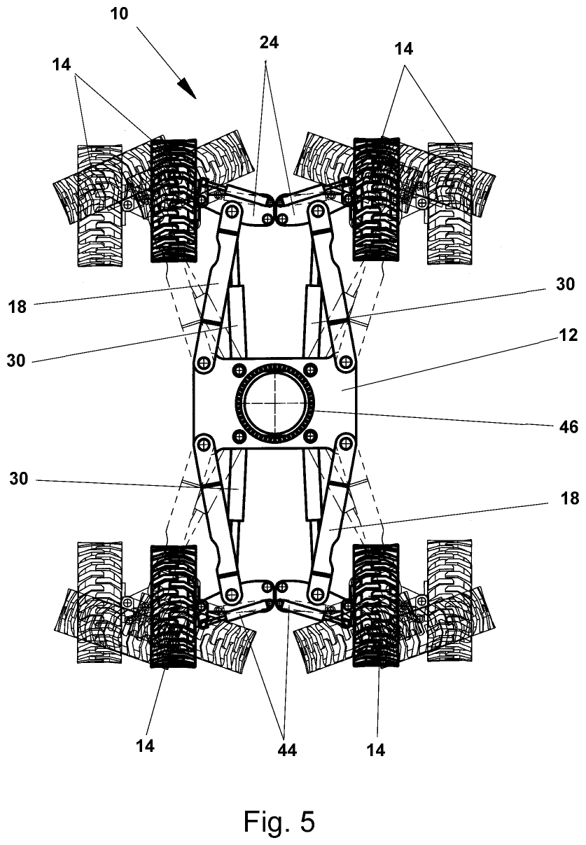

Finally, FIG. 5 shows all the steering positions of the four wheels 14 and the associated positions of the supporting devices 16 (partly dashed) in the transport position, in the two intermediate positions and in the operating position.

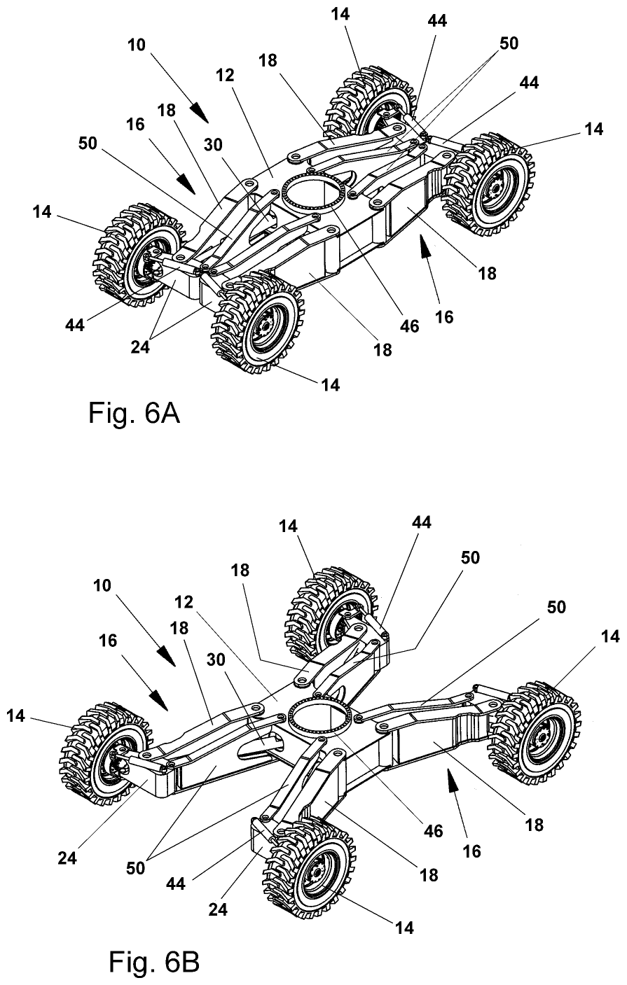

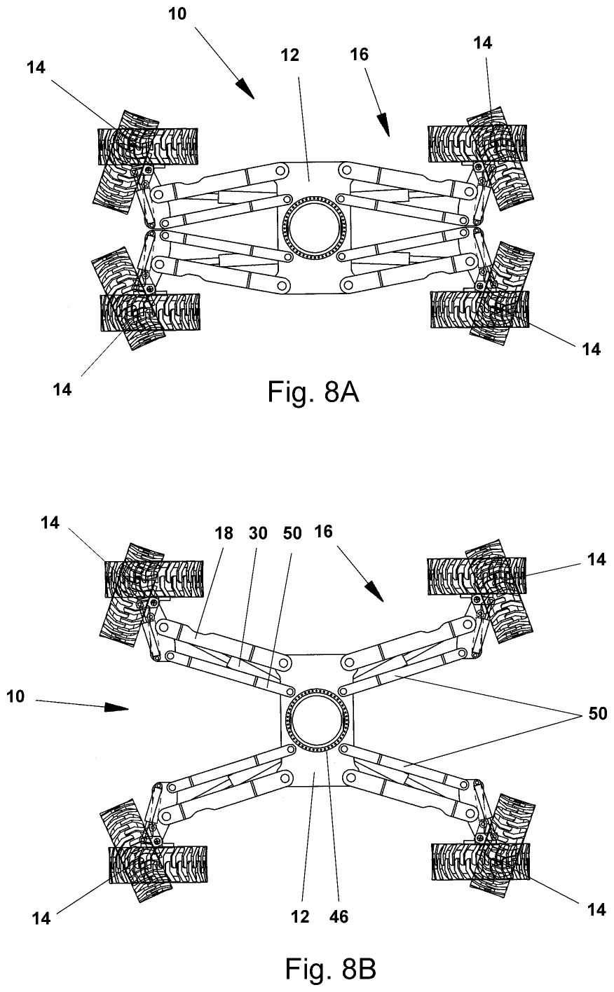

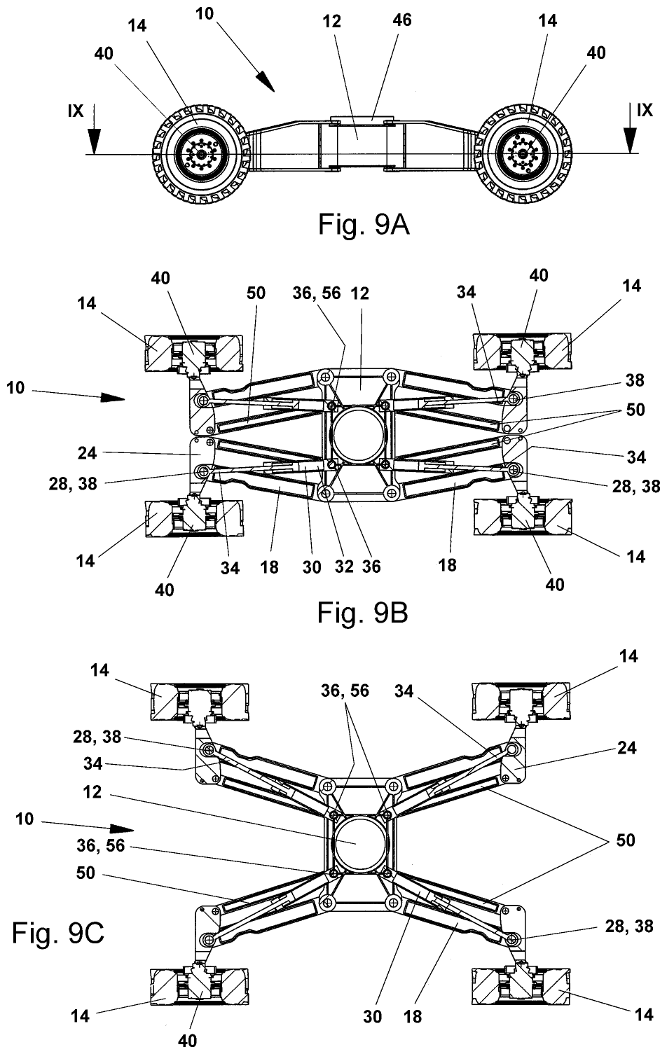

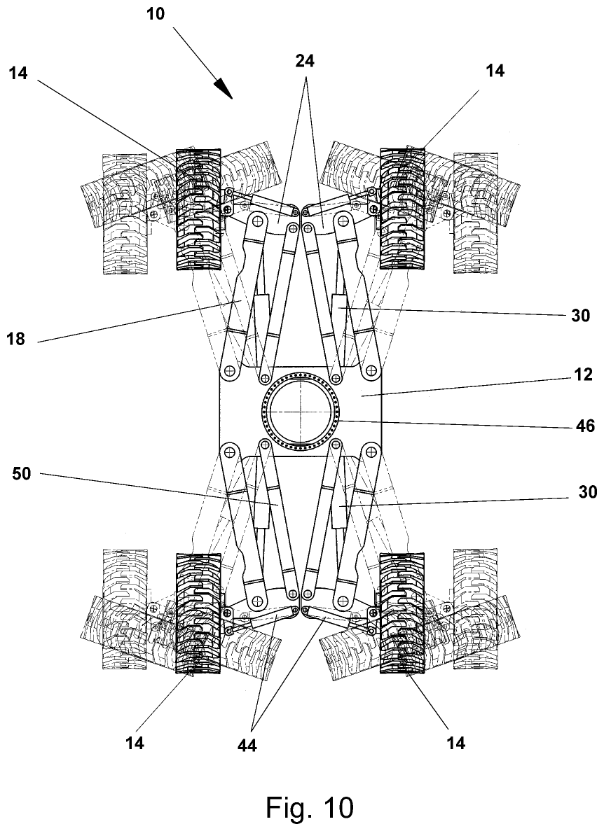

In FIGS. 6A to 10 a further embodiment of the chassis 10 according to the invention is shown.

The embodiment according to FIGS. 6A to 10 differs from that of FIGS. 1A to 5 essentially in that each supporting device 16 additionally comprises a parallel guide 50.

The parallel guides 50, for example in the form of a further support or carrier arm, are designed in the embodiment of the chassis 10, as can be seen from FIGS. 6A to 10, to be smaller in their dimensions or dimensioning, respectively, than the support or carrier arms 18. However, without being shown in detail, the parallel guides 50 can have the same or even larger dimensions or dimensioning, respectively, as the support or carrier arms 18. This depends essentially on the force and moment conditions that occur and must be adapted constructively as desired as well as individually to the respective load characteristics of the chassis 12.

Although the embodiment of the chassis 10 of FIGS. 1A to 5 has already highly proven itself in practice, the parallel guides 50 of the vehicle chassis 10 according to the invention can additionally increase the overall stability of the chassis 10 and extend its service life. Furthermore, this results in improved tracking accuracy and fidelity of the chassis 10. This results at the same time in a simplified, equally very precise handling of the chassis 10 in operation. Finally, the first controls 30 can be protected by the parallel guides 50 against damage or even complete destruction, for example in the event of a collision if obstacles on the travel path of the chassis 10 are overlooked by the operating personnel due to carelessness.

In the embodiment of the chassis 10 shown in FIGS. 6A to 10, each parallel guide 50 is assigned to the corresponding support or carrier arm 18. Thereby, the parallel guide 50 is rotatably arranged to the base 12 via a proximal end 52 and rotatably connected to the axle journal 24 at a distal end 54 here. For this purpose, a first axis of rotation 56 is provided between the base 12 and the proximal end 52 of the parallel guide 50 and a second axis of rotation 58 is provided between the distal end 54 and the axle journal 24.

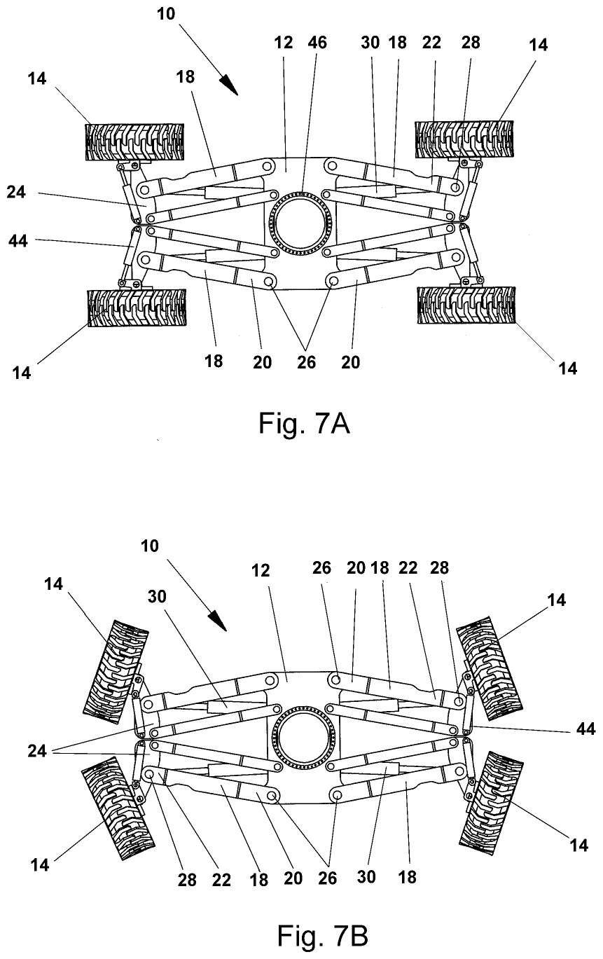

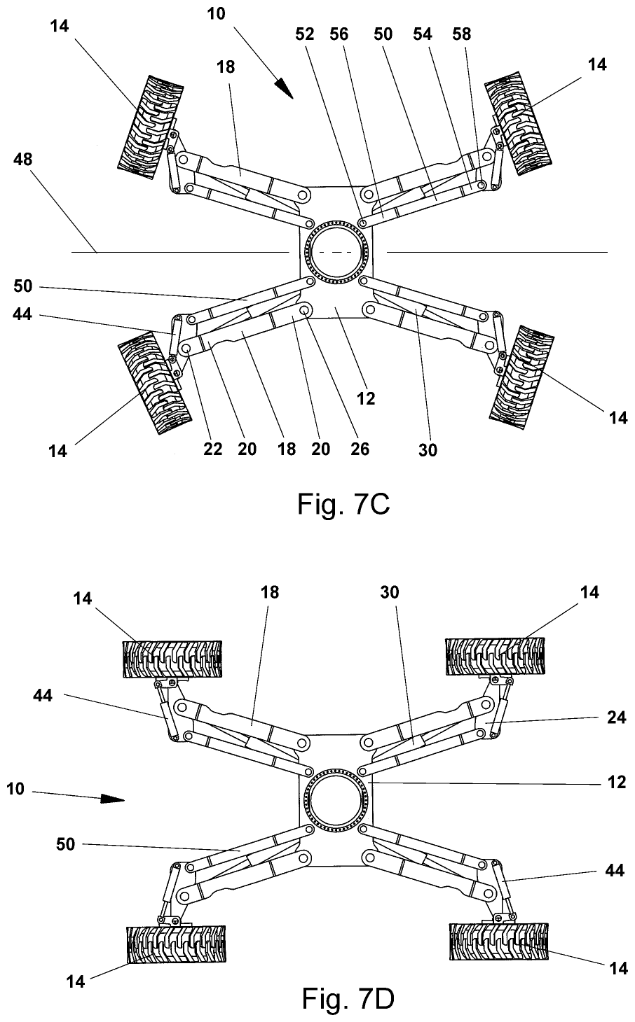

As can be seen in particular from FIGS. 7A to 8B and 9B to 10, the parallel guide 50 is arranged between the support and carrier arm 18 and the longitudinal axis 48 of the chassis 10. In particular, the parallel guide 50 is aligned substantially parallel to the respective support and carrier arm 18. Preferably, the parallel guide 50 and the support and carrier arm 18 thereby form, for example, a parallelogram together with the base 12 and the axle journal 24.

Furthermore, in the embodiment of the chassis of FIGS. 6A to 10, the first axis of rotation 56 of parallel guide 50 and base 12 and the first axis of rotation 36 of first control 30 and base 12 coincide. This simplifies the construction and allows for weight savings.

In all other respects, the two embodiments of the chassis 10 according to the invention shown in FIGS. 1A to 5 and in FIGS. 6A to 10 are identical. In this respect, reference is made to the preceding description of the embodiment of FIGS. 1A to 5.

The invention is not limited to the embodiments shown. Without being shown in detail, it is possible to combine the various embodiments of the chassis 10 according to the invention or chassis and its individual components with each other or with each other individually and as desired, respectively. The same applies to the method(s) according to the invention and its/their use. For example, it is possible to form separately on/at the axle journal 24 the second axis of rotation 28 of support or carrier arm 18 and axle journal 24 and the second axis of rotation 38 of first control 30 and axle journal 24. In contrast to the illustrated embodiment examples of the chassis 10 according to the invention as shown in FIGS. 1A to 10, in which the axes of rotation 28, 38 and 36, 56 coincide in each case, it is also possible— without being shown in

detail—to form the axes of rotation 28 and 38 and/or the axes of rotation 36 and 56 in each case individually, i.e., independently of one another, thus not coinciding, as well as to arrange them at different locations on base 12 and axle journal 24.

1. Chassis comprising a base (12) and four wheels (14) each being mounted on the base (12) by way of a respective supporting device (16) and each being capable of being brought out of a transport position into an operating position of the chassis (10), and vice versa, wherein each supporting device (16) comprises:
A support or carrier arm (18), which is arranged on the base (12) via a proximal end (20) to be pivotable out of the transport position into the operating position of the chassis, and vice versa, and at a distal end (22) receives an axle journal (24) for rotation,
a first control (30) for pivoting the support or carrier arm (18) out of the transport position into the operating position of the chassis, and vice versa,
the axle journal (24) rotatably arranged at the distal end (22) of the support or carrier arm (18),
a stub axle (40), which is pivotably arranged on the axle journal (24) and receives the wheel (14) for rotation at a distal end (42) of the axle journal (24), and
a second control (44) for pivoting the stub axle (40) against the axle journal (24).

2. Chassis according to claim 1, characterized in that the support or carrier arm (18) is rotatably arranged at the base (12) with the proximal end (20) via a first axis of rotation (26) from the transport position to the operating position of the chassis (10), and vice versa, and is rotatably connected to the axle journal (24) at the distal end (22) via a second axis of rotation (28).

3. Chassis according to claim 1 or 2, characterized in that the first control (30) for pivoting the support or carrier arm (18) from the transport position into the operating position of the chassis (10), and vice versa, is rotatably arranged on the base (12) with a proximal end (32) via a first axis of rotation (36) and is rotatably connected to the axle journal (24) at a distal end (34) via a second axis of rotation (38).

4. Chassis according to claim 1, characterized in that the second axis of rotation (28) of support or carrier arm (18) and axle journal (24) and the second axis of rotation (38) of first control (30) and axle journal (24) coincide.

5. Chassis according to claim 1, characterized in that the first control (30) and/or the second control (44) is/are designed to be adjustable in length.

6. Chassis according to claim 1, characterized in that the first control (30) and/or the second control (44) is/are designed to be hydraulically, pneumatically, mechanically or electrically length-adjustable.

7. Chassis according to claim 1, characterized in that the first control (30) and/or the second control (44) is/are designed as a, in particular telescopic, pressure cylinder, hydraulic unit, linear unit, spindle unit or linear motor.

8. Chassis according to claim 1, characterized in that each supporting device (16) further comprises a parallel guide (50) assigned to the support or carrier arm (18), rotatably arranged at a proximal end (52) on the base (12) and rotatably connected at a distal end (54) to the axle journal (24).

9. Chassis according to claim 1, characterized in that the parallel guide (50) is arranged between the support and carrier arm (18) and the longitudinal axis (48) of the chassis (10), in particular substantially parallel to the support and carrier arm (18).

10. Chassis according to one of claims 1 to 9, characterized in that the parallel guide (50) and the support and carrier arm (18) together with the base (12) and the axle journal (24) form approximately the shape of a parallelogram.

11. Chassis according to claim 1, characterized in that the first axis of rotation (56) of parallel guide (50) and base (12) and the first axis of rotation (36) of first control (30) and base (12) coincide.

12. Chassis according to claim 1, characterized in that the wheels (14) and/or the first control (30) and/or second control (44) is/are designed to be controllable individually, in pairs or all together.

13. Chassis according to claim 1, characterized in that the base (12) has a turntable (46), slewing ring or similar bearing device, via which a superstructure, revolving tower, work cage, work platform or other lifting device for the transport of persons and tools can be arranged in a rotatable manner.

14. Method of operating a mobile or self-propelled working machine, working platform or the like having a chassis according to claim 1, characterized in that the wheels (14) on the supporting devices (16) are each aligned for moving or adjusting the width of the chassis (10) from the transport position to the operating position, and vice versa, each at an angle to the longitudinal axis (48) of the chassis (10) in such a way that the wheels (14) are each guided or aligned on, substantially on or parallel to a pitch circle about which/on which the supporting devices (16) are pivoted or moved.

15. Use of a chassis according to claim 1 for mobile, movable, lifting and lowering, self-propelled working machines, working platforms, working cages, working platforms, excavators, machines for dredging, walking excavators, construction equipment and machines, boom lifts, earth-moving machines, earth drills, lifting platforms, lifting equipment for the transport of people and goods, hoists, aerial work platforms, lifting platforms, lifting tables, cranes, slewing cranes, construction cranes, truck cranes, overhead cranes, gantry cranes, tower cranes, crane or tool attachments or mounts for machine tools.
